(19) United States
(12) Patent Application Publication
(10) Pub. No.: US 2012/0256769 A1
(43) Pub. Date: Oct. 11, 2012

(54) SYSTEM AND METHOD FOR REAL-TIME DETECTION OF AN EMERGENCY SITUATION OCCURING IN A VEHICLE

(75) Inventor: Manoranjan SATPATHY, Bangalore (IN)

(73) Assignee: GM GLOBAL TECHNOLOGY OPERATIONS LLC, DETROIT, MI (US)

(21) Appl. No.: 13/082,227

(22) Filed: Apr. 7, 2011

(51) Int. Cl. G08G 1/123; B60Q 1/00

(52) U.S. Cl. 340/989; 340/425.5

(57) ABSTRACT

A system for real-time detection of an emergency situation occurring in a vehicle includes, but is not limited to, a first sensor that is configured to detect an occupant-related condition and to generate a first signal that includes information relating to the occupant-related condition. The system further includes a transmitter that is configured for wireless transmissions. The system further includes a processor that is communicatively coupled to the first sensor and operatively coupled to the transmitter. The processor is configured to obtain the first signal from the first sensor and to determine when an emergency situation is occurring based, at least in part, on the information included in the first signal. The processor further configured to instruct the transmitter to transmit a distress signal without any involvement by an occupant of the vehicle when the processor determines that an emergency situation is occurring.

### TECHNICAL FIELD

The technical field generally relates to a vehicle, and more particularly relates to a system and a method for the real-time detection of an emergency situation occurring in a vehicle.

### BACKGROUND

Emergency situations in a vehicle, such as the perpetration of a crime against an occupant of the vehicle, the occurrence of an incapacitating medical event, a collision that is about to occur, and a collision that has just occurred, can arise suddenly and may take a driver of the vehicle by surprise. In some instances, the sudden onset of an emergency situation in the vehicle may deprive the occupant of the vehicle of an opportunity to alert first-responders (e.g., law enforcement officials and/or medical professionals) to the fact that an emergency situation is occurring. For this reason, first-responders typically remain unaware of the emergency situation as it is occurring and the emergency situation is allowed to proceed without intervention.

Accordingly, it is desirable to alert first-responders to the occurrence of emergency situation as early as possible. In addition, because of potential incapacitation on the part of the occupant of the vehicle, it is desirable to provide such notice to first-responders automatically, without requiring any action to be taken by the occupant of the vehicle. Furthermore, other desirable features and characteristics will become apparent from the subsequent detailed description and the appended claims, taken in conjunction with the accompanying drawings and the foregoing technical field and background.

### SUMMARY

Various embodiments of a system and method for real-time detection of an emergency situation occurring in a vehicle are disclosed herein.

In a first embodiment, the system includes, but is not limited to, a first sensor that is configured to detect an occupant-related condition and to generate a first signal that includes information relating to the occupant-related condition. The system further includes a transmitter that is configured for wireless transmissions. The system still further includes a processor that is communicatively coupled to the first sensor and that is operatively coupled to the transmitter. The processor is configured to obtain the first signal from the first sensor and to determine when an emergency situation is occurring based, at least in part, on the information included in the first signal. The processor is further configured to instruct the transmitter to transmit a distress signal without any involvement by an occupant of the vehicle when the processor determines that an emergency situation is occurring.

In another embodiment, the system includes, but is not limited to, a first sensor that is configured to detect an occupant-related condition and to generate a first signal that includes information relating to the occupant-related condition. The system further includes a transmitter that is configured for wireless transmissions. The system further includes a processor that is communicatively coupled to the first sensor and that is operatively coupled to the transmitter. The processor is configured to obtain the first signal from the first sensor and to determine when an emergency situation is occurring based, at least in part, on the information included in the first signal. The processor is further configured to instruct the transmitter to transmit a distress signal without any involvement by an occupant of the vehicle when the processor determines that an emergency situation is occurring. The system still further includes a communication center located remotely from the vehicle that is configured to receive the distress signal and to respond to the distress signal.

In another embodiment, the method includes, but is not limited to, the steps of detecting, with a sensor mounted in a vehicle, and occupant-related condition, communicating a signal containing information relating to the occupant-related condition to a processor, determining with the processor that an emergency situation is occurring in the vehicle, and transmitting a distress signal with a wireless transmitter without any involvement by the occupant when the processor determines that an emergency situation is occurring.

### DESCRIPTION OF THE DRAWINGS

One or more embodiments will hereinafter be described in conjunction with the following drawing figures, wherein like numerals denote like elements, and

FIG. 1 is a schematic view of a vehicle equipped with an embodiment of a system for real-time detection of an emergency situation occurring in the vehicle;

FIG. 2 is a schematic view of another embodiment of the system for real-time detection of an emergency situation occurring in the vehicle; and

FIG. 3 is a block diagram illustrating the steps of a method for real-time detection of an emergency situation occurring in a vehicle.

### DETAILED DESCRIPTION

The following detailed description is merely exemplary in nature and is not intended to limit application and uses. Furthermore, there is no intention to be bound by any expressed or implied theory presented in the preceding technical field, background, brief summary or the following detailed description.

A system and a method for the real-time detection of an emergency situation occurring in a vehicle is disclosed herein. In one example, the system may include one or more sensors positioned around the vehicle. Each sensor is configured to detect a condition indicative of an emergency situation. The system also includes a processor that is communicatively coupled to the one or more sensors to receive information provided by the one or more sensors. The processor is configured to determine whether an emergency situation is occurring in the vehicle based on the information provided by the one or more sensors. The system also includes a transmitter operatively coupled to the processor. The processor is configured to control the transmitter to transmit a distress signal when an emergency situation is detected. As used herein, the term “emergency situation” refers to the perpetration of a crime, an act of violence against an occupant of the vehicle, a medical emergency experienced by an occupant of the vehicle, a collision that is about to occur and/or a collision that has already occurred. For example, and without limitation, the system disclosed herein could be used to detect the occurrence of a kidnapping, a carjacking, an assault, a battery, a heart attack, seizure, a stroke, a front end collision, etc. experienced or about to be experienced by the driver or another occupant in the passenger compartment of the vehicle.

When a person experiences an emergency situation, their behavior and their physiology changes. The rate at which a person speaks, the volume at which a person speaks, the language used by a person, the strength with which that person grips the steering wheel, and the speed of their movements (or, in the case of a collision, the absence of movement by a person) when that person is faced with an emergency situation typically differs from the rate of speech, the volume of speech, the language used by the person, their grip on the steering wheel and their body movements when not facing an emergency situation. For example, a person facing an emergency situation may scream or yell or otherwise speak at a much higher volume than when that person is not facing an emergency situation. Similarly, the person facing an emergency situation may utter expletives that the person might otherwise not utter in the absence of emergency situation.

The person facing the emergency situation will experience elevated levels of stress which may manifest or otherwise be detectable in that person's physiology. For example, a person's heart rate or blood pressure during an emergency situation will typically differ from their heart rate and blood pressure during a non-emergency situation. The person may sweat more profusely during an emergency situation than during a non-emergency situation. The person's rate of respiration may increase during an emergency situation. The tone and characteristics of the person's voice may also change in a manner that is indicative of the elevated level of stress they are experiencing. Many additional detectable behavioral and physiological changes may be manifested by a person when facing an emergency situation.

In addition to behavioral and physiological changes, the distraction caused by the emergency situation will, in many instances, have a detectable impact on the dynamic state of the vehicle. For example, a driver experiencing a heart attack or being kidnapped at gunpoint may be distracted from the task of operating a vehicle. In other instances, the perpetrator of the crime and the driver of the vehicle may struggle over control of the vehicle. Such distraction and/or struggle for control may result in erratic vehicle dynamics. For example, the vehicle may leave the paved road and travel over broken or uneven terrain or side road resulting in a bumpy and jerky ride. In some instances, the vehicle may turn sharply or stop or accelerate suddenly.

The behavioral and physiological changes experienced by a person faced with an emergency situation will be referred to herein as an occupant-related condition. The detectable impact on the dynamic state of the vehicle will be referred to herein as a vehicle-related condition. An occupant-related condition may be detectable through the use of various sensors positioned in and around the passenger compartment of the vehicle. A vehicle-related condition may also be detectable through the use of various sensors placed at any suitable location on the vehicle. Such sensors are communicatively coupled with the processor and are configured to send signals to the processor that contain information indicative of the occupant-related condition and the vehicle-related condition.

The processor is configured to receive and evaluate all of the information provided by the various sensors to determine whether an emergency situation is occurring. If the processor determines that an emergency situation is occurring, the processor is configured to instruct the transmitter to wirelessly send a distress signal to another entity. In some embodiments, the other entity may be a first responder such as a dispatcher of law enforcement agents or a dispatcher of emergency medical technicians while in other embodiments, the other entity may be a communication center that is configured to receive and to respond to such distress signals. In such embodiments, the communication center may select an appropriate first responder and then contact that first responder to request assistance on behalf of the vehicle occupant experiencing the emergency situation.

A further understanding of the above described system and method for the real-time detection of an emergency situation occurring in a vehicle may be obtained through a review of the illustrations accompanying this application together with a review of the detailed description that follows.

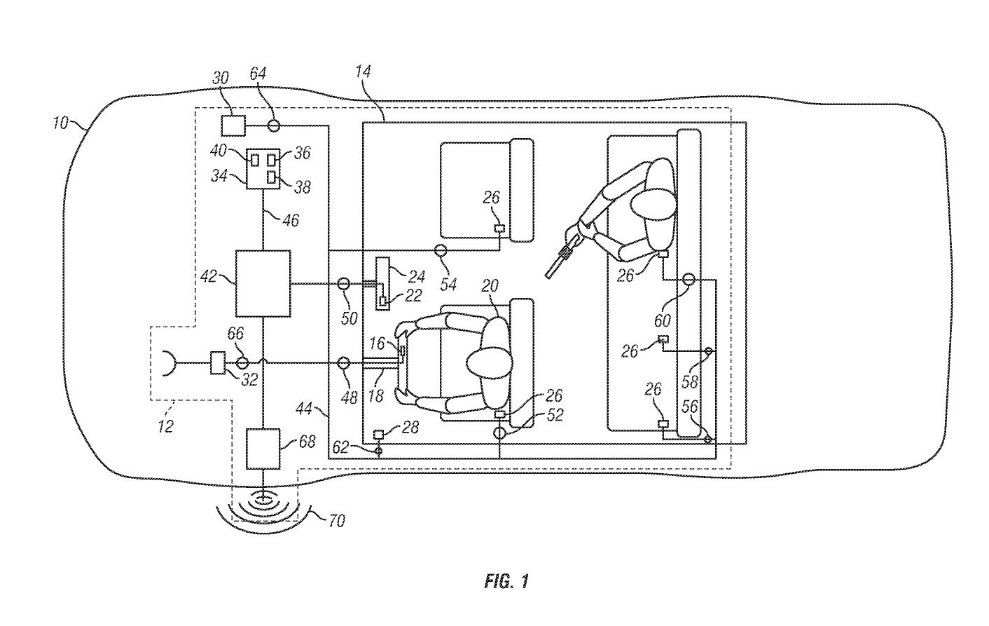

FIG. 1 is a schematic view of a vehicle 10 equipped with an embodiment of a system 12 for real-time detection of an emergency situation occurring in vehicle 10. The emergency situation depicted in FIG. 1 is a criminal act (e.g., a kidnapping) but it should be understood that the systems and methods described below are equally applicable to emergency situations entailing medical emergencies, pending collisions, and the aftermath of collisions. Additionally, although vehicle 10 is depicted in FIG. 1 as a passenger sedan, it should be understood that the system disclosed and described herein is compatible with any type of vehicle including automobiles, trains, aircraft, and water craft.

In the embodiment illustrated in FIG. 1, system 12 includes a plurality of occupant-related condition sensors mounted within passenger compartment 14 that are configured to detect different types of occupant-related conditions. For example, a biometric sensor 16 is disposed on a steering wheel 18 and is configured to detect a physiological condition of an occupant 20. Biometric detectors are well known in the art and may be configured to detect the occupant's pulse rate, blood pressure, respiration rate, the rate of sweat secretion, the strength with which the occupant grips the steering wheel, or any other detectable a physiological condition.

Another occupant-related condition sensor mounted within passenger compartment 14 is a microphone 22 mounted to a rearview mirror 24. Microphones are well known in the art. Microphone 22 may be configured to detect any audible sound within passenger compartment 14. Accordingly, microphone 22 may be used to detect the volume and rate of speech of any occupant within passenger compartment 14, both of which may be indicative of the occurrence of an emergency situation. Microphone 22 may also be used to detect elevated levels of stress manifested in the voice of occupant 20 as occupant 20 experiences the emergency situation. In some embodiments, voice recognition software may be used in conjunction with microphone 22 to detect the utterance of certain words, such as expletives, or certain phrases which may typically be spoken during an emergency situation (e.g., “Oh my God” or “put your hands up”).

Another occupant-related condition sensor mounted within passenger compartment 14 are seat sensors 26. Seat sensors are well known in the art and may be configured to detect the presence of an occupant in the seat associated with the seat sensor. Seat sensor 26 may be positioned at each seating position within passenger compartment 14 and may be used to detect the presence of an occupant in a seat, and the sudden appearance of one or more additional occupants within passenger compartment 14. The presence or absence of an occupant within passenger compartment 14 other than the driver could be useful in assessing whether or not an emergency situation is occurring and also the type of emergency situation that is occurring. The sudden appearance of additional occupants within passenger compartment 14 may also be useful in assessing whether an emergency situation is ongoing within passenger compartment 14. For example, the sudden appearance of additional occupants within passenger compartment 14 coupled with a sudden detection of elevated levels of stress in the voice of occupant 20 by microphone 22 and further coupled with a sudden increase in the pulse rate of occupant 20 as detected by biometric sensor 16 may lead to the conclusion that occupant 20 is experiencing an emergency situation.

Another occupant-related condition sensor mounted within passenger compartment 14 is a video camera 28. Video camera 28 may face inwardly into passenger compartment 14 to observe activities occurring within passenger compartment 14. Video camera 28 may provide corroborating evidence of the arrival of additional occupants, may be used to detect the occurrence of violent conduct due to the perpetration of a criminal act within passenger compartment 14, may be used to detect the onset and occurrence of symptoms associated with medically incapacitating conditions, and may be used to observe occupant-related conditions for the purposes of subsequent incrimination and/or diagnosis. In some embodiments, an additional or secondary video camera may be included which faces outwardly from the vehicle to record the road conditions. Information provided by such an outwardly facing video camera may be used to determine whether an emergency situation is ongoing. For example, the forward view of the road surface may reveal ice or other weather-related conditions that would have an impact on a driver's control of vehicle 10 and which would provide an explanation of vehicle dynamic behavior that otherwise might be associated with an emergency situation. In addition, a radar sensor may be provided to measure the distance between vehicle 10 and a vehicle positioned ahead of or approaching vehicle 10. Such a radar sensor may provide information useful in detecting a pending collision.

It should be understood that the above described occupant-related condition sensors are exemplary in nature and a greater or lesser number of occupant-related condition sensors may be used with system 12 without departing from the teachings presented herein. In addition to the above described occupant-related condition sensors, many other types of occupant-related condition sensors may also be used to observe/detect occupant conduct and physiological responses. For example, a door sensor may be associated with each door of passenger compartment 14 to detect whether a door is open or closed and may therefore assist in determining the occurrence of the ingress and egress of an occupant. A door lock sensor may also be associated with each door of passenger compartment 14 and may be configured to detect the locking or unlocking a door lock. Such a door lock sensor may be useful in determining that an emergency situation is ongoing (e.g., someone may reach into passenger compartment 14 through an open window, unlock the door, and gain access to passenger compartment 14 without the consent of the driver). A motion sensor may be positioned within passenger compartment 14 to detect the movement of occupants inside passenger compartment 14 and may therefore detect the type of motion that typically occurs during emergency situations. Additional biometric sensors may be positioned at each seating position in passenger compartment 14 to collect physiological data related to each occupant of passenger compartment 14.

In the embodiment illustrated in FIG. 1, system 12 also includes a plurality of vehicle-related condition sensors mounted to the vehicle 10 and that are configured to detect different types of vehicle-related conditions. For example, an accelerometer 30 is positioned in an engine compartment of vehicle 10. Accelerometers are well-known in the art and are configured to determine the acceleration of a body in motion. When no emergency situation is ongoing within passenger compartment 14, the ride dynamics of vehicle 10 will generally fall within a predetermined range. For example, straight-line acceleration of vehicle 10 and the rate at which vehicle 10 turns to the right or to the left will generally fall within a normal range. During emergency situations, when a driver is either distracted or panicked, the straight-line acceleration and the rate at which vehicle 10 turns to the right to the left may vary from the normal range. Accelerometer 30 is configured to detect such motions of vehicle 10.

Another vehicle-related condition sensor is a position-determining unit 32. Position determining units are well-known in the art and are configured to determine the geographical location of vehicle 10. One common type of position determining unit that is commonly used in a vehicle is a global positioning system that receives signals broadcast by satellites in geosynchronous orbit around the Earth and which triangulates the signals received from different satellites to determine the location of the vehicle on the surface of the earth. Data related to the position of the vehicle may be useful in determining the occurrence of emergency situations. For example, if vehicle 10 is traveling through a geographic area known to have an elevated crime rate, then the location information coupled with information provided by the various occupant-related condition sensors within passenger compartment 14 may lead to the determination that occupant 20 is experiencing an emergency situation involving the perpetration over criminal act. In another example, if vehicle 10 is traveling through a geographic area known to have very high temperatures, then the location information coupled with information provided by the various occupant-related condition sensors within passenger compartment 14 may lead to the determination that occupant 20 is experiencing an emergency situation involving a medical emergency of a sort typically associated with high temperatures.

In addition to the above described vehicle-related condition sensors, many others may also be used to observe/detect vehicle dynamic behavior. For example, vehicle 10 may be equipped with a yaw sensor, a roll sensor, and a dive sensor which may be used in a manner similar to accelerometer 30 to assess/detect dynamic behavior of vehicle 10. Vehicle 10 may include a speedometer which may be used to detect certain vehicle dynamic conditions (e.g., high rates of speed) which typically accompany an emergency situation. Additionally, sensors may be used to detect the ride height and/or suspension travel of the suspension system of vehicle 10. Excessive suspension travel may indicate that vehicle 10 has left a paved surface and thus may indicate that an emergency situation is in progress. It should be understood that the above described vehicle-related sensors used with system 12 are exemplary in nature and a greater or lesser number of vehicle-related condition sensors may be used with system 12 without departing from the teachings presented herein.

System 12 may further include a memory unit 34. Memory unit 34 may be any type of electronic memory device that is configured to store data, including, but not limited to, non-volatile memory, disk drives, tape drives, and mass storage devices and may include any suitable software, algorithms and/or sub-routines that provide the data storage component with the capability to store, organize, and permit retrieval of data. In an embodiment, memory unit 34 is configured to store data file 36 which includes information relating to historical occupant-related conditions. For example, data file 36 may include information relating to historical heart rates, blood pressure measurements, and respiration rates for a driver or occupant of vehicle 10. In some embodiments, a separate data file 36 may be recorded for each driver of vehicle 10 and may be correlated through any suitable means including, but not limited to, the selection of a memory seating position, the weight of the occupant as detected by seat sensor 26 and/or a unique biometric identifier detected by a biometric sensor such as biometric sensor 16. In other examples, data file 36 may include information relating to vehicle occupancy correlated with time of day. Memory unit 34 may be further configured to store data file 38 which may contain information relating to historical vehicle-related conditions (e.g., typical speeds and driving habits, typical destinations, etc.). Memory unit 34 may be further configured to store data file 40 which may contain information relating to crime statistics for different areas within a geographic region (referred to herein as “geographically correlated crime related data”) and which may associate particular criminal activity with particular geographic locations. In some embodiments, system 12 may omit memory unit 34 without departing from the teachings of the present disclosure.

System 12 further includes a processor 42. Processor 42 may be any type of onboard computer, computer system, or microprocessor that is configured to perform algorithms, to execute software applications, to execute sub-routines and/or to be loaded with and to execute any other type of computer program. Processor 42 may comprise a single processor or a plurality of processors acting in concert, in an embodiment. In some embodiments, processor 42 may be dedicated for use exclusively with system 12 while in other embodiments processor 42 may be shared with other systems on board vehicle 10.

Processor 42 is communicatively coupled to each of the occupant-related condition sensors (biometric sensor 16, microphone 22, seat sensors 26, and video camera 28), to each of the vehicle-related condition sensors (accelerometer 30 and position determining unit 32), and to memory unit 34. In the illustrated example, processor 42 is communicatively coupled with the other components via a wired connection (e.g., processor 42 is connected to the occupant-related condition sensors and the vehicle-related condition sensors via a vehicle bus 44 and is connected to memory unit 34 via a dedicated wire 46. Vehicle bus 44 and dedicated wire 46 may be any type of wire, cable, lead, or other physical connection suitable for carrying signals between electronic components. In other embodiments, processor 42 may be communicatively coupled to the occupant-related condition sensors, the vehicle-related condition sensors, and memory unit 34 via a wireless connection including, but not limited to, a short range radio communication protocol (e.g., BlueTooth, WiFi, etc. . . . ).

Being communicatively coupled provides a pathway for the transmission of commands, instructions, interrogations and other signals between processor 42 and each of the other components. Each of the occupant-related condition sensors are configured to transmit a signal to processor 42 containing information indicative of a detected occupant-related condition. For example, biometric sensor 16 is configured to transmit signal 48 to processor 42 containing information indicative of detected biometric conditions relating to occupant 20. Microphone 22 is configured to transmit signal 50 to processor 42 containing information indicative of sounds detected within passenger compartment 14, such as sounds emitted by an occupant and/or sounds made by vehicle 10 such as when a collision occurs. Seat sensors 26 are configured to send signals 52, 54, 56, 58, and 60 to processor 42 containing information indicative of either the presence or absence of an occupant from a respective seat. Video camera 28 is configured to send signals 62 to processor 42 indicative of video information collected from within passenger compartment 14. Similarly, each of the vehicle-related condition sensors are configured to transmit a signal to processor 42 containing information indicative of a vehicle-related condition. For example, accelerometer 30 is configured to transmit signal 64 to processor 42 containing information relating to acceleration of vehicle 10. Position determining unit 32 is configured to send a signal 66 to processor 42 containing information relating to the current position of the vehicle 10.

Through the communicative coupling between processor 42 on the one hand, and the occupant-related condition sensors and the vehicle-related condition sensors on the other hand, processor 42 may receive the information needed to determine whether an emergency situation is currently occurring within passenger compartment 14. Various strategies may be employed by processor 42 to determine whether an emergency situation is occurring within passenger compartment 14. In an embodiment, the information provided by each of the varying sensors may be considered and weighed in order to determine whether an emergency situation is occurring. For example, signal 60 may indicate that a new occupant has entered vehicle 10. Signal 48 may indicate a sudden and significant increase in the pulse rate of occupant 20 signal 50 may indicate elevated levels of stress in the voice of occupant 20. Processor 42 may also be loaded with voice recognition software which may be used to detect the use of certain keywords or phrases indicative of an emergency situation. Signal 64 may indicate that the vehicle has just rapidly accelerated from a motionless condition. Signal 66 may provide information indicating the current geographical location of vehicle 10 which, together with the information contained in data file 40 may indicate a vehicle 10 is presently traveling through the region with a high crime rate. Through the use of various filters and software applications, processor 42 may be configured to synthesize the information provided with each of these signals to determine that occupant 20 is experiencing an emergency situation. The combination of information from multiple sensors to derive more accurate and dependable information is known as sensor fusion. Sensor fusion may contribute to a greater confidence in the conclusion that an emergency situation is occurring. A greater or lesser number of signals indicative of an emergency situation may also be used to determine that an emergency situation is occurring without departing from the teachings of the present disclosure.

System 12 further includes a transmitter 68. Transmitters are well-known in the art and transmitter 68 may be any type of transmitter suitable for wirelessly transmitting signals including, but not limited to, an RF transmitter. Transmitter 68 is operatively coupled with processor 42 and is configured to respond to instructions from processor 42. When processor 42 determines that an emergency situation is occurring, processor 42 is configured to instruct transmitter 68 to transmit a distress signal 70. Distress signal 70 may contain information pertaining to the emergency situation occurring inside the passenger compartment 14, vehicle 10 and occupant 20. For example, distress signal 70 may provide information indicating that a kidnapping is in progress. Distress signal 70 may also include the vehicle identification number for vehicle 10, a general description of vehicle 10, the condition of occupant 20, and video or photographic images from the interior of vehicle 10. In other embodiments, distress signal 70 may include all information collected by the multiple occupant-related condition sensors and the multiple vehicle-related condition sensors.

In some embodiments, processor 42 may be configured to direct distress signal 70 to an appropriate first responder such as a law enforcement agency or a medical agency such as a hospital or ambulance dispatcher. In some embodiments, memory unit 34 may include data files relating to the location of first responders and may use the information contained in signal 66, which is indicative of the present location of vehicle 10, to select an appropriate first responder. In other embodiments, processor 42 may instruct transmitter 68 to transmit distress signal 70 to one or more vehicles within a predetermined distance of vehicle 10. In other embodiments, such as one discussed below, processor 42 may be configured to transmit distress signal 70 to a centralized communication center that is configured to respond to such distress signals. In still other embodiments, processor 42 may be configured to transmit distress signal 70 to other components of vehicle 10. For example, in the case of a pending vehicle collision, distress signal 70 may contain instructions to various components, such as seat belt pretensioners, smart headrests, and smart braking systems to actuate.

System 12 is configured to transmit distress signal 70 without any involvement by occupant 20. Occupant 20 may be incapacitated by a medical emergency, an assailant, or injuries sustained during a collision, or may otherwise lack the autonomy necessary to call for help. In such situations, system 12 would be able to request assistance on behalf of occupant 20 without requiring occupant 20 to interact with system 12.

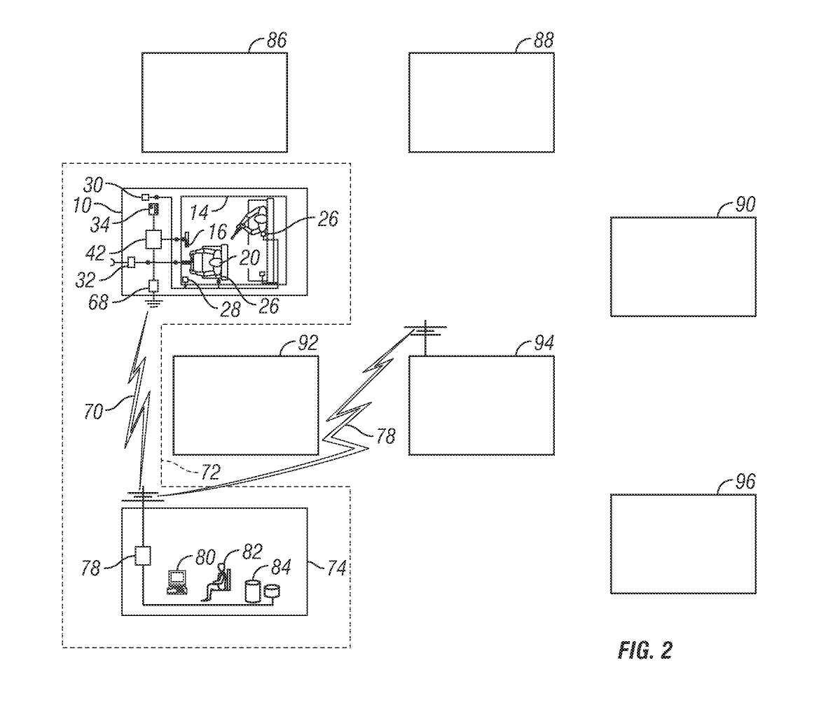

FIG. 2 is a schematic view of another embodiment 72 of a system for real-time detection of an emergency situation occurring in vehicle 10. With continuing reference to FIGS. 1-2, embodiment 72 includes all of the components and elements of system 12 and adds to it a communication center 74. Communications center 74 is located remotely from vehicle 10 and may communicate with vehicle 10 via a wireless communications network. In some embodiments, system 12 may be compatible for use with existing communication networks such as those which are currently used by telematics service providers. System 12 may communicate with communication center 74 using such communications networks. An example of an existing communication network used by telematics service providers is disclosed and described in U.S. Pat. No. 7,865,282 which is hereby incorporated herein by reference in its entirety.

The illustrated embodiment of communication center 74 includes a receiver 78, a server 80, a live advisor 82, and a data storage unit 84. In other embodiments, communications center 74 may be configured differently and may omit one or more of the listed components. For example, in some embodiments, communications center 74 may be an automatic system that does not include live advisor 82.

Receiver 78 is configured to receive distress signal 70. In some embodiments, receiver 78 may comprise a transceiver capable of transmitting as well as receiving. Server 80 is configured to run software, receive distress signal 70 from receiver 78 and to route distress signal 70 to an appropriate recipient. In some embodiments, an appropriate recipient may be live advisor 82 while in other embodiments, server 80 may be configured to respond to distress signal 70 autonomously. Data storage unit 84 may contain information pertaining to vehicle 10 and the owner of vehicle 10 as well as information pertaining to other vehicles monitored by communications center 74.

In an embodiment, communication center 74 is configured to receive distress signal 70 and to determine the nature of the emergency situation facing occupant 20 of the vehicle 10 as well as the current location of vehicle 10. Utilizing this information, communication center 74 may identify several first responder agencies that are suitably situated to provide assistance to occupant 20. For example, communication center 74 may identify agency 86, agency 88, agency 90, agency 92, agency 94, and agency 96, all of which may fall within a predetermined distance of the present location of vehicle 10. Communications center 74 is configured to determine which of these several agencies are best suited to render assistance to occupant 20. This determination may be made by either server 80 or live advisor 82 and may be based on the number of relevant factors. For example, if it is determined that the emergency situation facing occupant 20 is criminal in nature, communication center 74 may determine that the best course of action would be to notify a law enforcement agency. Accordingly, if agencies 86, 88, and 90 are hospitals or other types of medical first-responders, communication center 74 may eliminate those agencies from further consideration and would limit further analysis to agencies 92, 94, and 96. In other situations, such as during a post-collision scenario, communication center 74 may determine that it is appropriate to contact both medical first-responders and also law enforcement agents. Communications center 74 may utilize information contained in data storage unit 84 to further narrow down and select an appropriate first-responder. For example, data storage unit 84 may include information about the resources available at each potential first-responder and may therefore be able to assess the ability of each potential first-responder to assist occupant 20.

In the illustrated example, by utilizing such information, communication center 74 has selected agency 94 to provide assistance to occupant 20. Accordingly, communication center 74 transmits signal 98 to agency 94 requesting that assistance be provided to occupant 20 of vehicle 10. Communication center 74 transmits signal 98 to agency 94 in any suitable manner including via the transmission of RF signals, through the use of cell phone or landline telephone networks, through the use of satellite communications, or in any other suitable manner. Signal 98 may comprise a data signal or it may comprise a voice communication between live advisor 82 and a human first responder. In examples where signal 98 comprises a data signal, signal 98 may include a wide array of information including any and all information provided by system 12 in distress signal 70 as well as information stored in data storage unit 84 that is relevant to the provision of rescue services to occupant 20.

In some embodiments, wherein distress signal 70 is received at communication center 74, communication center 74 may be configured to seek confirmation that occupant 20 is experiencing an emergency situation and to collect additional information about the emergency situation. For example, communication center 74 may be configured to view the interior of passenger compartment 14 by accessing a live feed from video camera 28 or microphone 22. Such observation/monitoring could be done silently, without requiring any interaction with occupant 20. In other embodiments, communication center 74 may be configured to establish communication with occupant 20 to confirm the occurrence of an emergency situation.

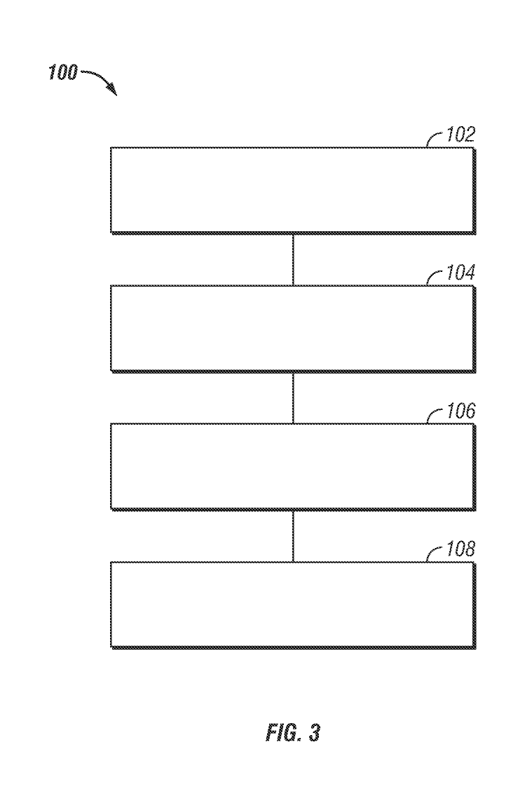

FIG. 3 is a block diagram illustrating the steps of a method 100 for real-time detection of an emergency situation occurring in a vehicle. At block 102, an occupant-related condition is detected. One or more sensors that are configured to detect an occupant-related condition may be positioned within the passenger compartment of the vehicle and may be configured to observe the vehicle occupant(s) to detect the occupant-related condition. Occupant-related conditions detected by these sensors may include, but are not limited to, elevated levels of stress, increased pulse rate, elevated blood pressure, increased grip strength on the steering wheel, the presence of the new occupant within the passenger compartment of the vehicle, the volume and rate of speech and the utterance of certain words or phrases.

At block 104, each sensor generates a signal that includes information relating to the occupant-related condition detected by each respective sensor, and then transmits that signal to a processor onboard the vehicle. Each signal may either be sent over a wire or sent wirelessly depending upon how the system employing method 100 is configured.

At block 106, the processor receives the signals and the information contained within each signal from each sensor and then determines whether an emergency situation is occurring within the vehicle. In some embodiments, the processor may also be configured to determine the type of emergency situation that is occurring within the vehicle. In still other embodiments, the processor may also be configured to determine what information should be included in a distress signal (e.g., type of crime occurring, biometric information, a photograph of the vehicle interior, etc. . . . )

At block 108, after determining that an emergency situation is occurring, a distress signal is transmitted to a first-responder. Such distress signal is sent without any involvement by any occupant within the vehicle. This ensures that in situations where one or more occupants are incapacitated by the emergency situation, the distress signal will, nevertheless, be sent.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

What is claimed is:

1. A system for real-time detection of an emergency situation occurring in a vehicle, the system comprising:
a first sensor configured to detect an occupant-related condition and to generate a first signal that includes information relating to the occupant-related condition;
a transmitter configured for wireless transmissions; and
a processor communicatively coupled to the first sensor and operatively coupled to the transmitter, the processor configured to obtain the first signal from the first sensor and to determine when the emergency situation is occurring based, at least in part, on the information included in the first signal, and the processor further configured to instruct the transmitter to transmit a distress signal without any involvement by an occupant of the vehicle when the processor determines that the emergency situation is occurring.

2. The system of claim 1, further comprising a memory unit configured to store data, wherein the processor is operatively coupled to the memory unit and wherein the processor is further configured to determine when the emergency situation is occurring based, at least in part, on the data.

3. The system of claim 2, wherein the data comprises a historical occupant-related condition.

4. The system of claim 2, wherein the data comprises geographically correlated crime related data.

5. The system of claim 1, wherein the first sensor comprises a microphone.

6. The system of claim 1, wherein the first sensor comprises a video camera facing an interior portion of a passenger compartment of the vehicle.

7. The system of claim 1, wherein the first sensor comprises a biometric sensor configured to detect a physiological condition of the occupant of the vehicle.

8. The system of claim 7 wherein the biometric sensor is associated with a steering wheel of the vehicle and is configured to detect a pulse of the occupant.

9. The system of claim 1, further comprising a second sensor configured to detect a vehicle-related condition and to generate a second signal that includes information relating to the vehicle-related condition, wherein the processor is communicatively coupled to the second sensor and wherein the processor is further configured to determine when the emergency situation is occurring based, at least in part, on the information included in the second signal.

10. The system of claim 9, wherein the second sensor comprises an accelerometer.

11. The system of claim 9, wherein the second sensor comprises a location determining unit, wherein the system further comprises a memory unit configured to store geographically correlated crime related data, wherein the processor is operatively coupled to the memory unit, wherein the processor is further configured to determine when the emergency situation is occurring based, at least in part, on the geographically correlated crime related data and a location of the vehicle.

12. A system for real-time detection of an emergency situation occurring in a vehicle, the system comprising:
a first sensor configured to detect an occupant-related condition and to generate a first signal that includes information relating to the occupant-related condition;
a transmitter configured for wireless transmissions;
a processor communicatively coupled to the first sensor and operatively coupled to the transmitter, the processor configured to obtain the first signal from the first sensor and to determine when the emergency situation is occurring based, at least in part, on the information included in the first signal, and the processor further configured to instruct the transmitter to transmit a distress signal without any involvement by an occupant of the vehicle when the processor determines that the emergency situation is occurring; and
a communication center located remotely from the vehicle and configured to receive the distress signal and to respond to the distress signal.

13. The system of claim 12, wherein the communication center is further configured to identify a first-responder, to contact the first-responder, and to request assistance from the first-responder for the occupant.

14. The system of claim 13, wherein the distress signal includes a location of the vehicle and wherein the communication center is further configured to identify the first-responder based, at least in part, on the location of the vehicle.

15. The system of claim 12, wherein the communication center is further configured to contact the occupant to ascertain a status of the occupant.

16. The system of claim 12, further comprising a memory unit configured to store data, wherein the processor is operatively coupled to the memory unit and wherein the processor is further configured to determine when the emergency situation is occurring based, at least in part, on the data.

17. The system of claim 16, wherein the data comprises a historical occupant-related condition.

18. The system of claim 17, wherein the data comprises geographically correlated crime related data.

19. The system of claim 12, further comprising a second sensor configured to detect a vehicle-related condition and to generate a second signal that includes information relating to the vehicle-related condition, wherein the processor is communicatively coupled to the second sensor and wherein the processor is further configured to determine when the emergency situation is occurring based, at least in part, on the information included in the second signal.

20. A method for real-time detection of an emergency situation occurring in a vehicle, the method comprising:
detecting with a sensor mounted in the vehicle an occupant-related condition;
communicating a signal containing information relating to the occupant-related condition to a processor;
determining with the processor that the emergency situation is occurring in the vehicle; and
transmitting a distress signal with a wireless transmitter without any involvement by an occupant when the processor determines that the emergency situation is occurring.
